(19) United States
(12) Patent Application Publication
(10) Pub. No.: US 2002/0143634 A1
(43) Pub. Date: Oct. 3, 2002

(54) Wireless payment system

(76) Inventors: K. Anand Kumar, Pune (IN); Vellore Satyanarayan Raghu Veera Raghavan, Pune (IN)

Correspondence Address: NATH & ASSOCIATES PLLC, Sixth Floor, 1030 Fifteenth Street, N.W., Washington, DC, 20005, US

(21) Appl. No.: 09/820,962

(22) Filed: Mar. 30, 2001

(51) Int. Cl. G06F 17/60

(52) U.S. Cl. 705/18; 705/26

(57) ABSTRACT

A payment system and method of conducting a shopping transaction between a customer and a merchant utilizing an approval system over portable phone which controls the acceptance or rejection of the shopping transaction and a financial institution to provide credit or an account that can be debited to pay for the shopping transaction. A first communications link is used between the merchant and the computer approval system and a first customer identification code given by the customer to the merchant is transmitted over the first communications link to the computer approval system for validation thereby. If the first customer identification code is validated by the computer approval system, the computer approval system uses a different, second communications link to a portable wireless telephone that can be a cell phone to obtain the customer approval of the transaction and to obtain from the customer a second customer identification code. If this second customer identification code is validated by the financial institution, then the computer approval system transmits an approval of the transaction to the merchant over the first communications link. The shopping transaction can take place at a Point of Sale in which case the merchant utilizes a POS device for communicating with the computer approval system; and it can take place over the Internet in which case the merchant utilizes a web site for communicating with the customer.

### FIELD OF THE INVENTION

This invention relates to a method of doing business involving the purchase of goods and services, and in particular relates to the purchase of goods and services involving the use of a communication device.

### BACKGROUND OF THE INVENTION

Sales transactions in today's economy can be done by a number of mechanisms, including in person with direct contact with a merchant selling goods and/or services (called herein a Point of Sales (POS) transaction), by using a telephone, by using the Internet, by using the mail, and even by using an interactive cable television system. In the context of this application, the term merchant includes any party selling or offering for sale an item of goods or services, and can include a business person or another individual. The sales are consummated by a payment mechanism that is either a payment by cash, check, credit card or debit card. If payment is done by check, credit card or debit card, then a payment system must be used which usually involves a clearance center (CC). Most of the existing payment systems use a bank or other financial organization as the clearance center. Many sales establishments, which can include retail stores, telephone marketers, Internet web sites, or mail catalog centers, have business relationships with the clearance centers whereby the sales establishments can accept payments for the merchandise or services by a check, credit or debit card. In some personal point of service locations there are direct communication links with the clearance center. Usually these links are by dedicated telephone lines which connect, for example, an establishment's Point Of Sale or POS device that is a dedicated piece of hardware equipment and can include a sales establishment's keypad, a customer's keypad, or a card reader which can be combined with one of the foregoing or can be a separate piece of equipment.

Security is always of paramount importance in any point of sales transactions. Usually the security is in the form of a password, or Personal Identification Number (PIN), that only the customer or user of the payment mechanism knows. Naturally, the use of such passwords has numerous problems that include the user forgetting the password, the hardware equipment being faulty, or a compromise in the password. In the conventional systems in use today, there is also no mechanism or system to validate that the user of the password is who he or she says. The user simply enters the password and if correct, the transaction proceeds. Thus, there is clearly a need for a security system that is easy to use, yet also includes a user validation both so that a merchant and a customer, as well as a clearance center can be protected against imposters.

There are payment systems currently in use and others have been proposed to improve security and validation. One type of proposed system utilizes the fact that in today's societies all over the world there has been a huge adoption of portable wireless communications devices such as cell phones and wireless connection attachments to computers, and handheld Personal Assistance Managers. There has therefore developed a desire to utilize such portable wireless communications devices in payment systems. One problem, however, is that any payment system that incorporates such portable wireless communication devices should be compatible with conventional payment systems.

One method that utilizes a portable communication device is disclosed in U.S. patent to Jalili,, U.S. Pat. No. 6,088,683, entitled “Secure Purchase Transaction Method Using Telephone Number” and which is incorporated herein by reference. This method is restricted to the use of the Internet to select the desired goods and to place an order combined with the use of a telephone network to a processing center, with which the customer has previously registered, to effect the order and allocate payment. The method includes the customer placing an order over the Internet and providing his or her identifying information, including a telephone number; the merchant providing the purchase information, a purchase number and a merchant number to the processing center; the customer calling the processing center and providing a Personal Identification Number (PIN) and being automatically identified by the telephone system's Caller ID; the customer confirming the sale; and finally the processing center debiting and crediting the transaction. However, this system would not work effectively in Point of Sale personal transactions or in transactions initiated from other prior art registered telephone devices, and does not provide for easy integration into existing purchasing systems.

Other systems are disclosed in the following U.S. patents: Rose et al. U.S. Pat. No. 5,757,917; Ogram patent U.S. Pat. No. 5,822,737; Stein et al. U.S. Pat. No. 5,826,241; and Talati et al. U.S. Pat. No. 5,903,878, each of which is incorporated herein by reference. The Rose et al. system involves a registered customer initiating a transaction with a merchant. After receiving a message from the merchant, the payment system transmits a message to the customer requesting authorization and, if authorized, the transaction information is provided to the merchant over a secure network. The Ogram system involves an Internet-based transaction system where the customer submits a credit card number to the merchant, who in turn forwards it to a payment system. The payment system forwards a message describing the transaction to the customer. The Stein et al system involves an Internet-based payment system where a registered customer initiates a transaction with a registered merchant and the payment system queries the customer as to whether the transaction is valid. If validated by the customer, the payment system effects payment via a secure network and notifies the merchant. The Talati et al. system involves a payment system where a customer initiates a transaction with a merchant who then forwards transaction information to the payment system. The payment system requests approval for the transaction from the customer, provides the customer with a unique transaction identifier, and notifies the merchant. Still other systems are disclosed in U.S. patents to Chen et al. U.S. Pat. No. 5,590,197; to Bezos U.S. Pat. No. 5,727,163; to Mandler et al. U.S. Pat. No. 5,32,400; to Harwood et al. U.S. Pat. No. 6,058,250; to Nelson U.S. Pat. No. 6,061,718; and to Ray et al. U.S. Pat. No. 6,067,529, each of which is incorporated herein by reference.

In spite of the numerous existing or published payment systems, there is no system that can be easily integrated into existing payment systems, yet still use a second, very secure and widely available communication network to affect both a personal point of sale transaction and an Internet transaction.

### SUMMARY OF THE INVENTION

The present invention is directed to a wireless payment system that offers a new payment mechanism for users that have a portable wireless communications device, such as a portable telephone, which devices for the purposes of this application will be collectively referred to as a mobile device. The payment system of the present invention thus utilizes the convenience and adaptability of a mobile device. Such a payment mechanism offers more security to transactions by adding a Transaction Confirmation facility using conventional communications technologies, such as the Short Message Service or SMS and/or Interactive Voice Response or IVR technology.

In order to integrate the present wireless payment system into existing systems, there is required the formation of a strategic alliance with financial organizations and an alliance with telecommunication service providers. In the case of a point of sale transaction, there is a requirement to cooperate with a Point of Sale unit manufacturer to customize the device as per the product needs.

According to the present invention, three identification numbers are utilized in a transaction. A first number is a semi-public number because it is given to the merchant and is herein called a User Identification or User ID. The User ID is used to identify the customer involved in the transaction. Every transaction made using the present payment mechanism passes through a conventional payment system where there is an opportunity to compromise this PKN. A second identification number is called the Merchant IDentification number or MID and is used to identify the merchant involved in the transaction. This is required in the case of physical shopping and can be preprogrammed in the Point of Sale device allotted to the merchant. The present invention also utilizes a conventional Personal Identification Number, or PIN to identify the customer to the system, but this number is truly kept secret. Before the transaction is confirmed, the payment system authenticates the customer by asking him or her for his or her PIN.

A typical transaction utilizing a wireless payment system according to the present invention is as follows in which the example utilizes a customer making a personal visit to a retail sales establishment to buy some goods.

1. A merchant who has a system according to the present invention installed totals the prices of a customer who wishes to make a purchase. The merchant has a Point Of Sale (POS) device that allows the merchant to connect to a server that has been previously programmed to include a wireless payment system according to the present invention.

2. The customer gives the merchant his or her Payment Key Number.

3. The merchant keys in the customer's User Identification and the transaction amount.

4. The point of sale device sends the Merchant Identification Number, which previously has been programmed into it, and the User Identification and transaction amount to the server.

5. The server verifies the Merchant Identification Number

6. The server verifies the Payment Key Number.

7. The server verifies the transaction with a financial institution, such as a bank.

8. The server sends an SMS Message and/or an IVR to the customer detailing the transaction and asking for confirmation (acceptance or rejection) of the transaction.

9. The server receives a transaction accepted response from the mobile subscriber which includes the PIN.

10. The server receives transaction Rejection response from the mobile subscriber.

11. The server conveys transaction Acceptance Rejection to the point of sale device.

### BRIEF DESCRIPTION OF THE DRAWINGS

FIG. 1 is a schematic block diagram depicting the components of a first embodiment of a Wireless Payment System (WPS) according to the present invention in which a sales transaction takes place in person between a Purchaser or Buyer and a Merchant or Seller;

FIG. 2 is a system schematic diagram of the transaction flow in a personal sales transaction of the Wireless Payment System according to the present invention;

FIGS. 3A to 3G are combination flow charts of computer programs of parts of the Wireless Payment System which can be implemented on multipurpose digital computers and of an exemplary transaction according to the present invention, the transaction being viewed, respectively, by a merchant (A), by a WPS server (B), by the merchant (C), by a bank (D), by a customer (E), by the WPS server (F), and by the Bank (G).

FIG. 4 is a schematic block diagram depicting the components of a second embodiment of a Wireless Payment System according to the present invention in which a sales transaction takes place over the Internet between a Buyer and a Merchant having a web site.

### DESCRIPTION OF THE PREFERRED EMBODIMENTS

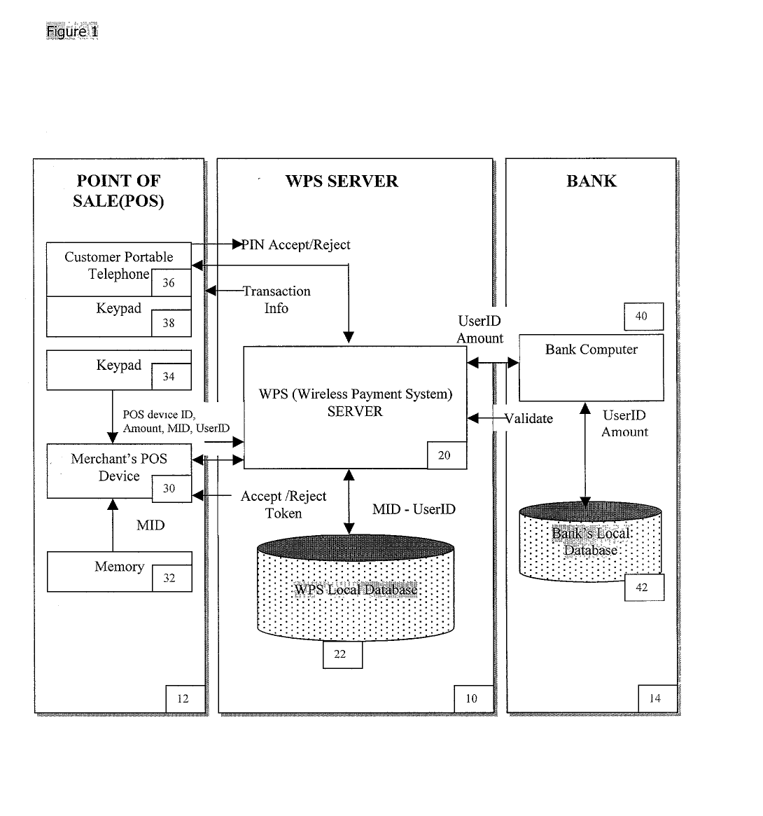

With reference now to the drawings in which the same numerals identify the same components throughout the several views, and in particular with reference to FIG. 1, there is a schematic block diagram depicting the components of a first embodiment of a Wireless Payment System according to the present invention in which a sales transaction takes place in person between a customer or buyer and a merchant. The system is divided into three general parts, a Wireless Payment System Server location or WPS server location 10 that is interconnected by communication links to a Point Of Sale (POS) location 12 and to a Financial Institution or Bank location 14. Although the three locations 10, 12, and 14 are depicted as three different physical locations, they could all be at the same physical location or at only two physical locations.

WPS server location 10 has a WPS server 20 connected, preferably hardwired, to a WPS local database 22. Server 20 is usually a conventional minicomputer, but could be a larger mainframe computer for very large systems or could be an enhanced microcomputer. Server 20 has been conventionally programmed to perform the conventional system functions as described herein, such as answer telephones, interchange information, provide conventional oral communications so that the system can interact with human beings, access database 22 and perform conventional authentication, validation and verification checks. Server 20 has also been programmed to perform the special steps of the present invention as set forth hereinbelow. Local database 22 is usually a conventional large storage off-line memory system, such as a magnetic tape storage system, but could be a hard drive in server 20 for smaller systems.

Point of sale location 12 includes a conventional merchant's POS device 30 connected to a memory 32 that contains that merchant's unique Merchant IDentification code (MID) and a conventional keypad 34 from which it receives an input provided by the merchant that includes a User Identification (User ID). The User ID is a semi-private or semi-secure code provided by the customer or buyer to a third person such as a merchant. As used herein, a code can include all numbers, all letters, an alphanumeric combination of letters and numbers, and a combination of any symbol or character, such as those defined in the extended ASCII character set. In conventional systems, the semi-private code is called the buyer's Personal Identification Number (PIN), although in this specification, that designation is used for a completely private code.. Memory 32 can be a conventional ROM or other non-volatile computer type memory. POS Device 30 can include a magnetic strip reader (not shown) that reads conventional identification cards, credit and debit cards, a communications modem (not shown), and a microprocessor (also not shown) that controls the sending of keypad inputted information and the MID. In a particular conventional type of POS device 30, there are the following components: a monochrome LED or bright LCD multi-line display; 7 function buttons that include a credit button, a debit button, a “yes” button, a “no” button, a cancel button, a clear button, and an enter button; a numeric keypad; a strip card reader; and a card reader/writer. In addition, in some embodiments POS device 30 can issue a hard copy receipt of the transaction for the customer and for the merchant for their respective retention

A merchant in this context is one who has goods or services to sell and has a system to accept payments by cash, by check, by credit card or by debit card. For a retail merchant that deals with customers in a physical transaction, the merchant needs to have POS device 30.

POS Device 30 is connected through a communications link to WPS server 20 and transmits data that includes a POS Device ID, the amount of the transaction, the MID number and the User ID. In one preferred embodiment which utilizes the Internet, WPS server 20 transmits a token and an accept/reject indication. The token (or “cookie”) is conventional and is stored on the POS Device 30 to enhance the system security, but is an optional feature. The communications link can be a conventional wireless transmission link, a conventional direct connection telephone line, an Internet communication link, or a similar type link.

Also shown at POS location 12 is a conventional customer portable telephone 36 having a keypad 38. Portable telephone 36 can be a cell phone or other type of portable phone that is carried by a user. Portable telephone 36 is depicted at POS location 12 because FIG. 1 is an example of equipment used in a personal transaction in which the customer and the merchant are physically in the same location. Portable telephone 36 is shown connected through a wireless telephone communication link with WPS server 20 through a conventional text to speech engine (not shown, but part of server 20) that utilizes Interactive Voice Response (IVR). The user uses IVR to provide the unique, totally private customer's PIN. Each portable telephone 36 identifies itself to a portable telephone system (not shown, but if it were it would be interposed in the connection between portable telephone 36 and WPS server 20) each time portable telephone 36 places or receives a call so that the portable telephone system can verify portable telephone 36 is a valid paying customer. The portable telephone system utilizes a telecommunication service provider to provide the network for the users who have a portable phone. It is the service provider that owns the pipe in the given geographical location.

Also, portable telephone 36 uses a conventional DTMF system (Dual Tone Multi-Frequency) to convey information indicated by a depressed key on keypad 38, and it has the conventional SMS system (Short Message Service) to convey and receive short alphanumeric messages. The DTMF system assigns a specific pair of frequencies, or tones, to each key so that it can easily be identified by a microprocessor.

The Short Message Service is a conventional service provided by the telecommunication service provider to permit the transmission of short text messages to and from a mobile phone, fax machine and/or IP address. In the present SMS protocol, messages must be no longer than 160 alphanumeric characters and contain no images or graphics. Once a message is sent, it is received by a Short Message Service Center (SMSC, not shown), which must then deliver it to the appropriate portable phone. To do this, the SMSC sends a SMS Request to a home location register (HLR) (not shown) to find the roaming customer. Once the HLR receives the request, it responds to the SMSC with the subscriber's status: 1) inactive or active; and 2) the location of the roaming subscriber. If the response is “inactive,” then the SMSC holds onto the message for a predetermined period of time. When a subscriber accesses his or her device at a later time, the HLR sends a SMS Notification to the SMSC, and the SMSC delivers the message. The SMSC transfers the message in a Short Message Delivery Point to Point format to the serving system. The system pages portable telephone 36 and if it responds, the message is delivered. The SMSC receives verification that the message was received by the end user, and then categorizes the message as “sent” and does not attempt to send the message again.

The IVR is a software application that accepts a combination of voice telephone input and touch-tone keypad selection and to provide appropriate responses in the form of voice and other media. An IVR application provides prerecorded voice responses for appropriate situations, access to relevant data, and potentially the ability to record voice input for later handling. Using a computer telephony integration IVR, applications can hand off a call to a human being who can view data related to the call at a display.

Thus WPS server uses a conventional corroboration mechanism to validate the identity of the caller, which can include Caller ID or the telephone number provided automatically by the portable telephone system. This identification validates the particular telephone and a conventional voice recognition software system is used to validate the customer. The identity of portable telephone 36 includes the phone number that is assigned by the telephone service provider. WPS server 20 sends transaction information back to portable telephone 36 and the customer indicates acceptance or rejection of the transaction, such as by saying “yes” or “no” or by entering in a code word from keypad 38 on portable telephone 36. The acceptance or rejection code word can be unique to the customer or more simply can be sending a “Y” or an “N.”. Bank location 14 includes a conventional bank computer 40 which communicates with a local database 42. Bank computer 40 is usually a conventionally programmed main frame computer which has also been programmed in accordance with the present invention as set forth below. Bank local database 42 is also conventional and can be a large tape drive system and a large hard disk (optical or magnetic) system.

Bank computer 40 is connected to WPS Server 20 over a conventional communication link and sends an acceptance/rejection and validation code to server 20 and receives the User ID and transaction amount from it. Bank computer 40 sends the transaction amount and User ID to local database 42 and receives financial information about the customer so that a determination can be made by the bank if it will accept the transaction. As with the local database of the WPS server 20, local in this context does not mean geographically local, but merely indicates that the data base is the one storing the financial records of the customer in a format most convenient to the data base user. The “local database” could be a shared data base and could be a data base located geographically distant from the computer.

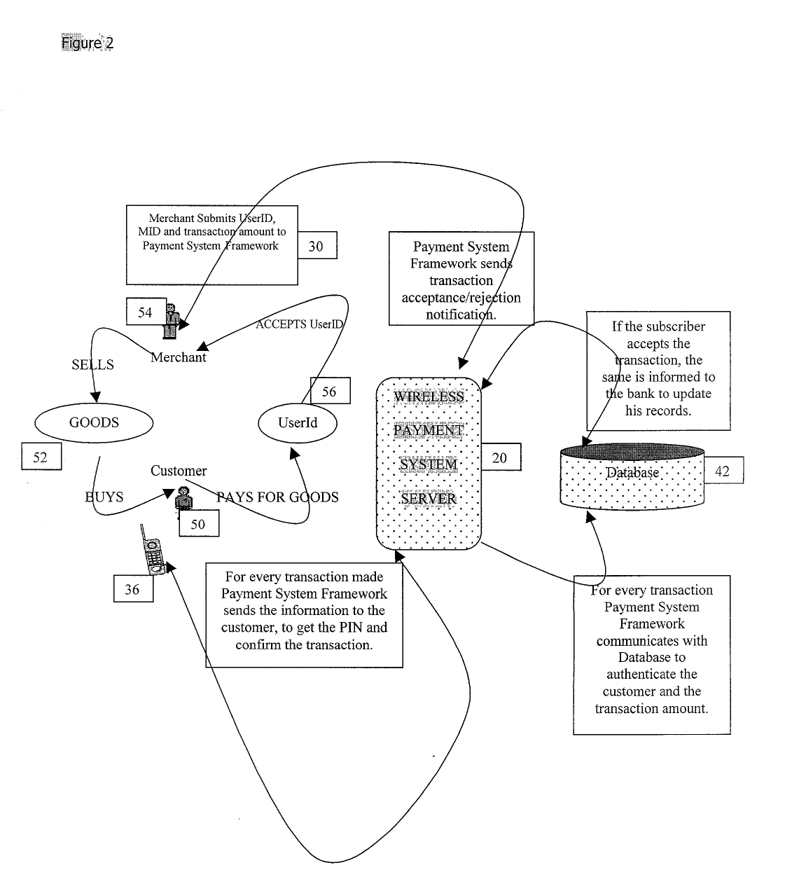

With reference now to FIG. 2, a real life scenario in a physical shopping trip using POS device 30 and a payment system according to the present invention will now be described. A woman customer 50 goes to a shopping mall to purchase some goods 52. She enters a store operated by a merchant 54 and makes her selections having a total transaction amount of $100. She then tells merchant 54 that she has a User ID code 56 and that she wants to use a payment by a Wireless Payment System (WPS) 20. She gives her User ID code 56 to merchant 54 who enters it, the merchant's MID code and the transaction amount of $100 into POS device 30 which sends them to WPS server 20. Alternatively, the MID code can be preprogrammed in POS device 30 which sends it automatically along with the User ID code 56 and the transaction amount. WPS server 20 receives this information and verifies the MID code, the POS device id code and User ID code 56. If the verification is successful, WPS server 20 creates a transaction record and assigns the transaction a transaction ID in its local database. WPS server 20 also generates a corresponding “token” for the transaction. The system state then becomes “Verified.”

WPS server 20 then sends the token to POS device 30 which receives it and records the token. POS device 30 in turn sends a go-ahead signal to WPS server 20 to process the transaction. The token must be recorded by POS device 30 and in a handshaking procedure WPS server 20 receives the token and validates it. The system state then becomes “Proceed.”

WPS server 20 communicates with bank computer 40, which then checks with bank database 42 whether customer 50 has an account and if so if that account has sufficient finds for the transaction for a debit card or if that account has sufficient credit available for a credit card. The customer's account is not debited as yet, but subsequent requests for other transactions would consider this transaction before approval. The system state then becomes “BankApproved.”

WPS server 20 then sends an SMS or IVR message to the mobile phone 36 of customer 50 requesting approval of the transaction. Customer 50 receives the SMS or IVR message on her mobile phone 36 and agrees to confirm the transaction by keying in an affirmation code, such as the letter “Y” (phone keypad number “9”) and keying in her PIN. Alternatively, she may reject the transaction such as by saying “No.” WPS server 20 receives the SMS or IVR message approving or rejecting the transaction and cross-checks the SMS or IVR originator telephone number for validity. The system state then becomes “CustomerApproved/rejected.”

WPS server 20 then instructs bank computer 40 to debit the amount (assuming that the transaction has been confirmed) from the account of customer 50, who in this example has an account in this bank, and credits the account of merchant 54. The system state then becomes “TransactionComplete/rejected.”

WPS 20 then sends an OK message to POS device 30 approving the transaction. Customer 50 takes her now purchased items along with a hard copy receipt from POS device 30 and merchant 54 takes his hard copy receipt and files it. The system state then becomes “Reset.”

This completes the transaction and customer 50 walks away happily. At the end of a business day, merchant 54 issues a command on POS device 30 to clear all transactions with the bank for that particular day.

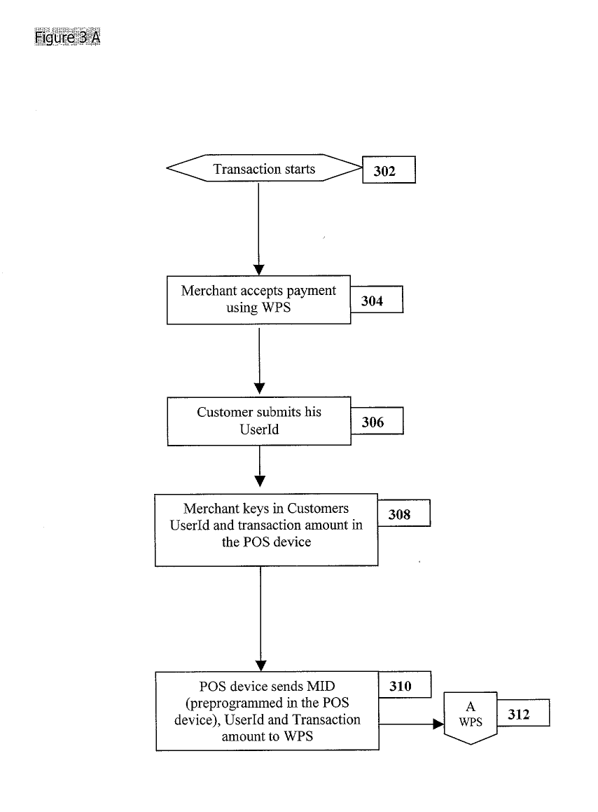

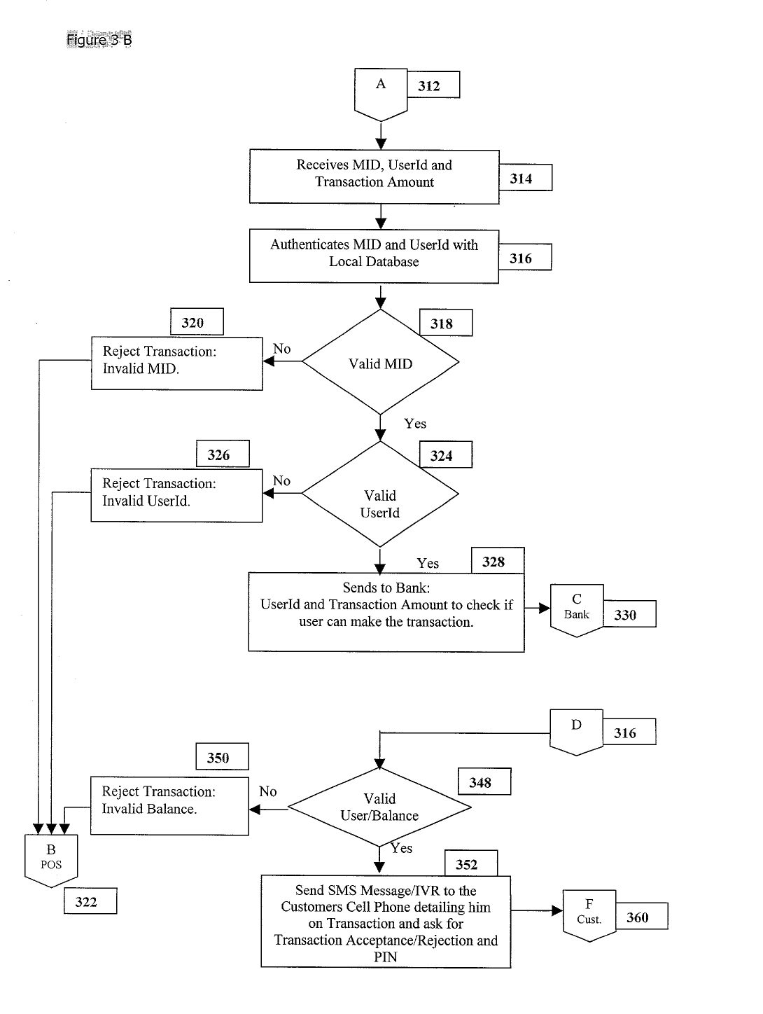

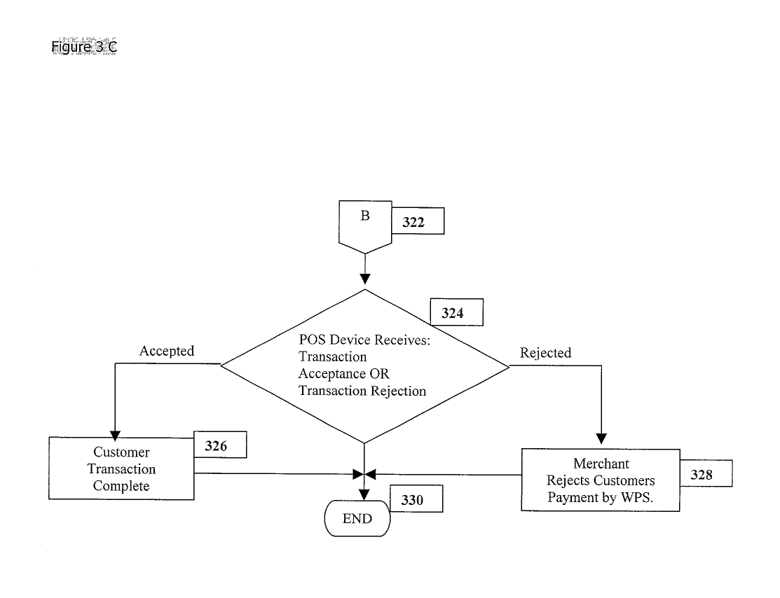

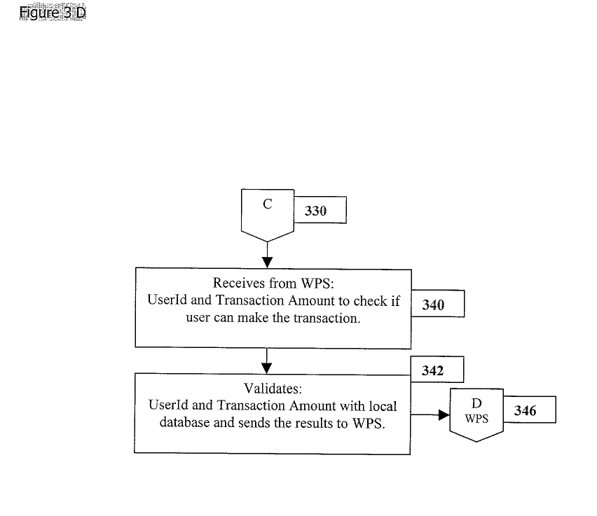

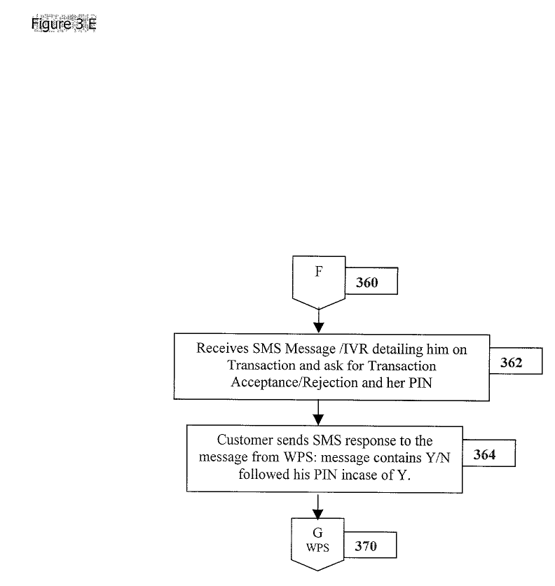

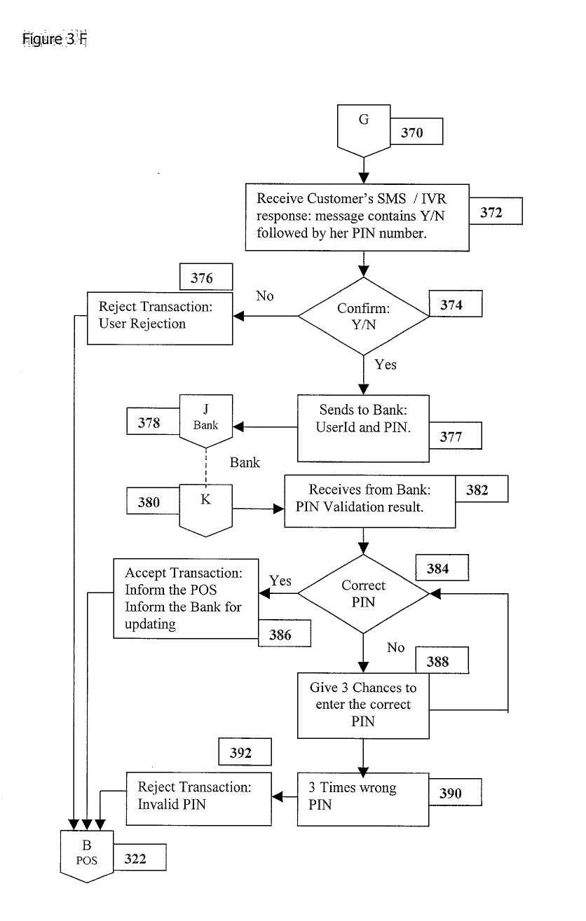

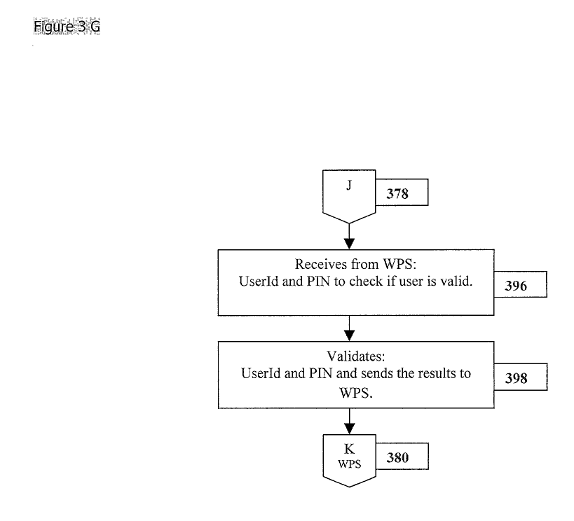

With reference now to FIG. 3, and in particular to FIG. 3A, an exemplary transaction between a merchant and a customer according to the present invention is depicted in flow chart form as seen by the merchant as the transaction begins, as indicated by a start symbol 302. The merchant accepts payment using the Wireless Payment System (WPS) as shown in processing box 304. The customer submits his or her purchase and semipublic User Identification (User ID) to the merchant, as shown in processing box 306, and the merchant keys in the User ID and the transaction amount in his Point of Sale (POS) device, as shown in processing box 308. Using a computer program, the POS device dials up (if not on-line) or connects (if on line) to the WPS server and transmits a Merchant IDentification number (MID), preprogrammed in the POS device, the User ID and the transaction amount to the WPS server, as depicted in processing box 310.

The transaction flow continues to FIG. 3B as indicated by an off-page connector symbol 312. FIG. 3B is representative of the transaction as viewed by the WPS server, and as shown in a processing box 314, the WPS server receives the transmitted MID, User ID and transaction amount. Using its local database, the WPS server authenticates the MID and PKN, as shown in a processing box 316. If the authentication of the MID by the WPS server is not valid, as depicted in a decision diamond 318, the process flow branches to a processing box 320 which symbolizes the server rejecting the transaction based on an invalid MID and continues the flow to the flow chart depicted in FIG. 3C as shown by an off-page connector 322. However, if the MID is authenticated, and the User ID is not, as shown in a second decision diamond 324, the process flow branches to a processing box 326 which symbolizes the server rejecting the transaction based on an invalid PKN. The process flow continues to flow chart depicted in FIG. 3C as shown by off-page connector 322. However, it the User ID is also determined to be valid, the process proceeds to a processing box 328 which symbolizes the WPS server connecting to a computer at a bank and transmitting the User ID and the transaction amount so that the bank can check if the user has a valid account with sufficient funds (for a check or debit card) or sufficient credit (for a credit card) for the transaction to proceed. This is symbolized by an off-page connector 330, which takes the process flow to FIG. 3D.

FIG. 3C is the transaction flow again as viewed by the merchant after certain validation and authentication steps have been performed. It represents the decision and subsequent action taken by the POS device. The process flow enters off-page connector from that depicted in FIGS. 3B and 3F, and the POS device determines if the transaction has been accepted or rejected, as indicated in a decision diamond 324. If the transaction has been accepted, the process flow branches to a processing box 326 where the customer transaction is marked as being completed and where routine housekeeping steps are taken (such as storing the result and printing a transaction slip). However, if the POS device determines that the transaction has been rejected, the process flow branches to a processing box 328 where the customer transaction is marked as being rejected and where routine rejection housekeeping steps are taken (such as storing the result and giving a visual indication, with or without a document being generated). From either processing box 326 or 328 the process flow proceeds to an end terminal 330, where the transaction is terminated.

The process flow comes to a bank, which is representative of a financial institution acting as a clearance center, from the WPS server, as indicated by off-page connector 330. The computer of the bank receives the User ID and the transaction amount, as indicated by processing box 340, so that they can be authenticated and validated by the local database of the bank, and so that the bank can make a determination whether the customer can make the transaction. After validating the User ID and transaction amount, and doing conventional housekeeping tasks (e.g. recording the amount of the transaction, the name of the merchant, the date, and changing the balance of the customer to reflect the transaction, and also doing traditional security transactions such as frequency of usage), as indicated in processing box 342, the transaction flow proceeds back to the POS device at the merchant's location, as depicted in FIG. 3B, through an off-page connector 346..

Returning to the process flow as depicted in FIG. 3B, the result of the authentication and validation by the bank of the customer's account is received and evaluated by the WPS server as indicated in a decision diamond 348. If the bank has rejected the transaction, the process flow branches to a processing box 350 which is indicative of the rejection, and thence to the merchant's POS device, as indicated by off-page connector 322, which was discussed hereinabove. If the bank has accepted the transaction, the process flow proceeds from decision diamond 348 to the step where the WPS server double checks the transaction by compiling a verbal message and sending or streaming the message to the customer via a completely separate, second communication loop that includes a portable phone of the customer. This is indicated in FIG. 3B by a processing box 352 in which the WPS server sends an SMS message or an IVR to the portable phone and requesting that the customer confirm the transaction. The portable phone and the user are validated and authenticated by requiring the customer to provide the unique PIN of the customer and an indication of acceptance or rejection of the transaction. The process flow branches back to the customer (depicted in FIG. 3E) as indicated by an off-page connector 360.

In FIG. 3E, as viewed by the customer, the portable telephone of the customer receives the User ID and transaction amount from the WPS server as indicated by off-page connector 360 so that the customer can decide if the transaction should be made, as is indicated in a processing box 362.. It is noted that if for some reason the customer changes his or her mind about the transaction and the customer for whatever reason is reluctant to tell the merchant, the customer can anonymously cancel the transaction. On the other hand, an obvious variant of the invention would be to provide the reason for the cancellation of a transaction to the merchant. The result of the decision of the customer is transmitted back to the WPS server by the portable telephone, as indicated in a processing box 364 together with the PIN of the customer. The process flow then returns to the WPS server as shown in FIG. 3F and as indicated by an off-page connector 370.

The process flow continues in the WPS server as indicated by off-page connector 370 as it receives the customer's SMS and/or IVR response to its inquiry for the customer's approval of the transaction and for the customer PIN. The response of the customer is processed by the WPS server as indicated by processing box 372 and the server determines if the transaction has been accepted or rejected as indicated by decision diamond 374. If the server determines that the customer has rejected the transaction, it branches to a processing of that response, as indicated by processing box 376, and then proceeds through off-page connector 322 to the POS device, as described hereinabove. On the other hand, if the WPS server determines that the customer has indicated an acceptance of the transaction, it branches from decision diamond 374 to processing that response and connecting to and sending the User ID and customer PIN to the bank, as indicated by processing box 377. The processing of that information is discussed hereinbelow, but the validation of the PIN received from the bank is processed as indicated by processing box 382, and a determination of a verified PIN branches the program through a decision diamond 384 to a processing box 386. Processing box 386 represents that verification by which the WPS registers the successful transaction and in a handshaking response indicates that to the bank and transmits that result to the POS device, as indicated by the process flow continuing through off-page connector 322. However, if the PIN is not verified as indicated in decision diamond 384, the customer is given two more chances to enter a correct PIN through appropriate intermediating with the bank and the portable phone, as indicated in processing box 388. A third incorrect PIN is registered as indicated in processing box 390 and processed as indicated in processing box 392 before the result is transferred to the POS device through off-page connector 322.

FIG. 3G shows the processing by the bank of the communications between the WPS server and the bank regarding the validation of the User ID and PIN. Both User ID and PIN are checked by the bank's computer as indicated by processing box 396 and the results communicated back to the WPS server as indicated by processing box 398 and off-page connector 380.

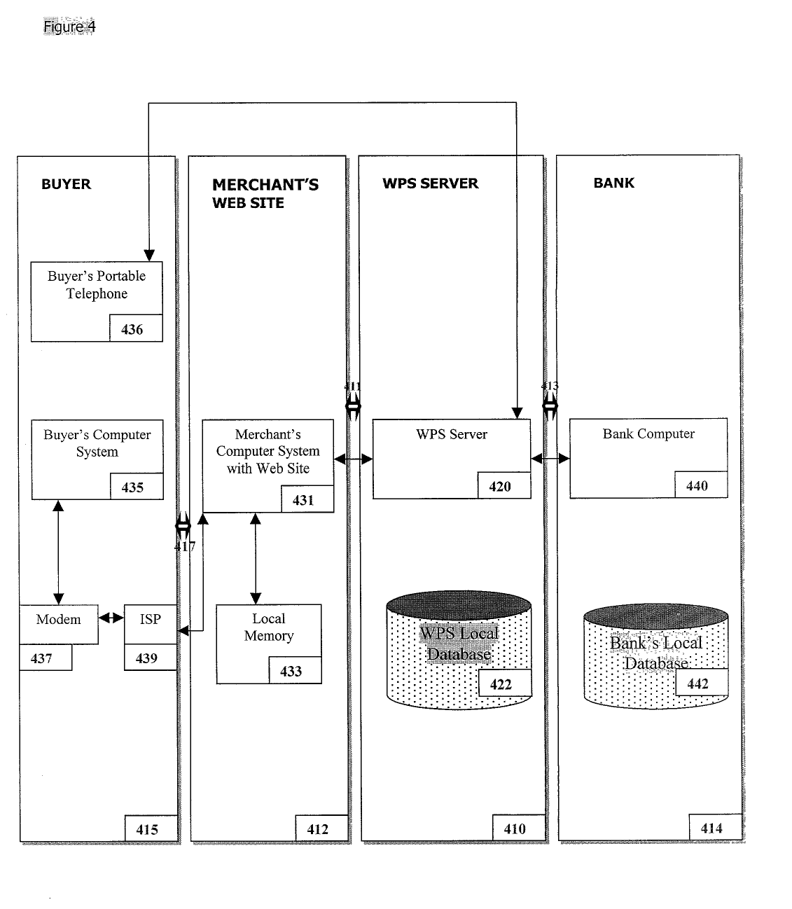

This completes the description of a flow chart depicting the handling of an exemplary transaction according to the present invention in which the transaction involved a POS device and personal meeting between the parties. The changes in the transaction and computer programming for other types of transactions would be obvious to those of ordinary skill in the art, which skill is shown by the incorporated US patents listed hereinabove. As an illustration, a second embodiment of a Wireless Payment System according to the present invention which utilizes a global communication network based sales transaction, such as the Internet and the World Wide Web, is described below with respect to FIG. 4.

The system is divided into four general parts. These parts include a WPS server location 410 that is interconnected by a communication link 411 that can be for example the Internet or a dedicated telephone line to a merchant's web site location 412 and via a separate communications link 413, that is a dedicated communication line such as a telephone line, to a bank location 414. The fourth part is a buyer's location 415 that is connected to the merchant's web site location 412 via a conventional Internet link 417. Although only one buyer's location 415 is depicted, it is representative of millions of buyer's locations all conventionally connected in parallel.

WPS server location 410 is identical to WPS server location 10 described hereinabove with respect to FIG. 1 and includes a WPS server 420 connected to a WPS local database 422.

Merchant's web site location 412 includes a merchant's computer system 431 hosting a web site connected to the Internet, indicated by link 417. Merchant's computer system 431 includes a conventional local memory 433. Computer system 431 is typically a conventional large and fast microcomputer and local memory is usually a conventional hard disk installed in the microcomputer.

Buyer's location 415, typified by that shown in FIG. 4, includes a buyer's computer system 435 and a user's portable telephone 436. Buyer's computer system is a conventional microcomputer and is depicted here as including an Internet connecting means that is a conventional, dial-up modem 437 and Internet Service Provider (ISP) 439. Buyer's portable telephone 436 is identical to portable telephone 36 described hereinabove with respect to FIG. 1.

Bank location 414 is identical to bank location 14 discussed hereinabove with respect to FIG. 1 and includes a bank computer 440 and a bank local database 442.

An exemplary real life scenario utilizing the present invention in e-commerce shopping is now described referring generally to FIG. 4. The process is very similar to physically shopping at a shopping mall, except that instead of going to the mall, a buyer or customer shops at an Internet website hosted by a merchant. The buyer, located at buyer location 415, turns on computer 435 and using a conventional communication connection software dials ISP 439 using modem 437. Once connected, the buyer activates a standard browser, accesses the Internet, and using the URL (Uniform Resources Locator) of the merchant, goes to the merchant's website, shown located at merchant's web site location 412. The buyer browses the web site and using the Internet provided software which is downloaded from the website, places the items that she wants to purchase in the “shopping cart.” Once all items to be purchased have been moved to the shopping cart, the buyer selects the Wireless Payment System method of making the payment. The buyer then enters in the payment details, enters her requisite PKN, and enters the other requisite details such as the address where the goods are to be delivered. The buyer then clicks on the submit button on the electronic form and the website software proceeds with the order.

The WPS server 420 and the bank computer 440 proceed as described above for a POS purchase and sale. The buyer receives an SMS and/or IVR message on portable telephone 436 asking for confirmation of the transaction and asking for her PIN. The buyer confirms or rejects the transaction and send her PIN in the case of confirmation to the WPS server420.

To handle the payments, the merchant needs to connect to the payment network using some software components that reside on merchant's computer system 431 which is acting as a web server and host to the online shopping. Most of these software components that communicate to the existing payment clearance network are available as Java Servlets/CGI scripts/COM components or in other conventional forms known to those skilled in the art. The merchant upon receiving indication of a confirmed sale, then physically ships the purchased merchandise to the buyer using conventional delivery methods.

The present invention provides greater security because of a combination of a payment identifier and a password; because of validation of the transaction by the customer or buyer, because of SMS inherent security; because of multiple levels of authentication and verification; and because of encryption of data.

Alternative embodiments of the present invention is possible. For example, the system could encompass a crash recovery mechanism, as a feature of WPS, to ensure uninterrupted data transmission. It can be incorporated in many different ways so as to leave the particular incorporation as an option for the hosting entity during implementation.

The present invention has now been described with respect to selected embodiments thereof. However, other embodiments would be obvious to those skilled in the art.

We claim:

1. A payment system for the secure purchase of goods and/or services by a buyer from a merchant during a sales transaction that involves a transaction amount, said system comprising:
a portable communication device operable on a first communication link when used by the buyer and capable of transmitting over said first communication link an acceptance or rejection of the sales transaction and of transmitting a buyer's secure PIN, said PIN being unique to the buyer, and capable of receiving over said first communication link information about the sales transaction;
a sales device used by a merchant that can communicate over a second communication link that is separate and not associated with said first communication link, said sales device being capable of transmitting over said second communication link a merchant identification code, the transaction amount, and a buyer semi-secure User ID and of receiving an acceptance/rejection indication; and
a system computer device that is connected to said portable communication device over said first communication link and connected to said sales device over said second communication link,
said system computer device capable of receiving and processing said PIN and said acceptance or rejection of the sales transaction from the buyer and capable of transmitting transaction information to said buyer, all over said first communication link, and
said system computer device capable of sending and receiving over said second communication link the merchant identification code, the transaction amount, and the buyer semi-secure User ID and of receiving over said second communication link an acceptance/rejection indication.

2. The payment system as claimed in claim 1 wherein said sales device is a POS device.

3. The payment system as claimed in claim 1 wherein said sales device is an Internet website.

4. The payment system as claimed in claim 1 and further including a financial institution computer system capable of receiving said User ID and said transaction amount from said system computer device over a third communication link, and capable of authenticating and validating the buyer and of processing said transaction amount to determine if the buyer has sufficient funds and/or credit to pay for said transaction amount..

5. The payment system as claimed in claim 4 wherein said buyer authenticating and validating uses said PKN.

6. A method of conducting a shopping transaction between a customer and a merchant for an item that can be goods and/or services, said item having a transaction amount, said method comprising:
a computer system receiving over a first communication link transaction information that includes the transaction amount from a sales device used by a merchant selling the item, a first customer identification code that is considered semi-private and that is unique to a customer, and a code identifying the merchant sales device;
the computer system transmitting over a second communication link transaction information to a portable communication device;
the computer system receiving over said second communication link a second identification code that is considered private and that is unique to the same customer that is identified by said first customer identification code and receiving a rejection code or an acceptance code indicating that the customer respectively rejects the transaction or accepts the transaction; and
the computer system transmitting an acceptance or rejection of the transaction to said sales device.

7. The method of conducting a shopping transaction as claimed in claim 6 wherein said sales transaction is a direct meeting between the merchant and the customer at a Point of Sales location.

8. The method of conducting a shopping transaction as claimed in claim 7 wherein said sales device is a POS device.

9. The method of conducting a shopping transaction as claimed in claim 6 wherein said sales transaction is conducted between the merchant and the customer over a global communications network.

10. The method of conducting a shopping transaction as claimed in claim 9 wherein said global communications network is the Internet; and wherein said sales device is a website hosted by the merchant and accessed by the customer.

11. The method of conducting a shopping transaction as claimed in claim 6 and further including the computer system transmitting over a third communication link transaction information and at least one of said first and said second identification codes to a financial institution; and
receiving from said financial institution over said third communication link a validation of said shopping transaction.

12. The method of conducting a shopping transaction as claimed in claim 11 wherein said at least one of said first and said second identification codes is said first identification code.

13. The method of conducting a shopping transaction as claimed in claim 6 wherein said portable communication device is a wireless portable telephone.

14. The method of conducting a shopping transaction as claimed in claim 6 wherein said merchant has a unique merchant identification code;
and further comprising the steps of said computer system checking the validity of said merchant identification code with a local data base accessible by said computer system, and
said computer system rejecting the shopping transaction if said merchant identification code is not valid.

15. The method of conducting a shopping transaction as claimed in claim 6 and further comprising the step of said computer system checking the validity of said first customer identification code with a local data base accessible by said computer system, and
said computer system rejecting the shopping transaction if said customer identification code is not valid.

16. A method of a merchant who has a unique merchant identification code conducting a shopping transaction with a customer who has a unique first, semi-private customer identification code and a second, private customer identification code, said shopping transaction being the selling of an item by the merchant to the customer for a transaction amount, said method comprising:
the merchant receiving the first customer identification code from the customer;
the merchant determining the transaction amount;
the merchant transmitting over a first communication link the transaction amount, the first identification code, and the merchant identification code to a computer approval system;
the customer receiving over a second communication link transaction information from the computer approval system;
the customer transmitting over the second communication link the second customer identification code and an acceptance or rejection of the shopping transaction to the computer approval system;
and the merchant receiving from the computer approval system an acceptance or rejection of the transaction.

17. The method of a merchant conducting a shopping transaction with a customer as claimed in claim 16 wherein said merchant uses a Point of Sale Device to communicate with said computer approval system.

18. The method of a merchant conducting a shopping transaction with a customer as claimed in claim 16 and further including the merchant hosting a selling website over the Internet and wherein said merchant communicates with the customer over the Internet.

19. The method of a merchant conducting a shopping transaction with a customer as claimed in claim 16 and further including the step of said computer approval system communicating with a financial institution to receive a validation of the transaction before communicating an approval or rejection with the merchant.

20. The method of a merchant conducting a shopping transaction with a customer as claimed in claim 16 wherein said customer receiving step includes the customer using a portable telephone for communicating with said computer approval system over a wireless telephone network; and
wherein said customer transmitting step includes the customer using said portable telephone for communicating with said computer approval system over said wireless telephone network.
